(19) United States
(12) Patent Application Publication
(10) Pub. No.: US 2010/0243281 A1
(43) Pub. Date: Sep. 30, 2010

(54) Method for controlling and putting down woodland fires

(76) Inventor: Sandro Pazzaglia, Milano (IT)

Correspondence Address: HEDMAN & COSTIGAN, P.C., 1230 AVENUE OF THE AMERICAS, 7th floor, NEW YORK, NY, 10020, US

(21) Appl. No.: 12/383,518

(22) Filed: Mar. 25, 2009

(51) Int. Cl. A62C 3/02; A62C 27/00; A62C 5/00

(52) U.S. Cl. 169/47; 169/70; 169/91; 169/52

(57) ABSTRACT

The present invention relates to a method for controlling and putting down woodland fires, said method comprising the steps of collecting earth at a region encompassing the fire region and projecting the collected earth to the combustion region as well as adjoining regions thereof.

### BACKGROUND OF THE INVENTION

The present invention relates to a method for controlling and putting down or extinguishing woodland fires.

As is known, methods used at present for putting down and controlling woodland fires are mainly based on a use of water which is preferably launched on the fire region by flying means.

Such a fire extinguishing method is obviously possible only in a case in which a water pool is available in comparatively near regions. Notwithstanding this, in several cases, a use of flying means has not been found as sufficient.

Moreover, in a case in which sea water is used, the sea water salt causes irreversible damages to the plants thereby, while the fire is finally extinguished, damages requiring a very long recovering time are generated.

### SUMMARY OF THE INVENTION

Accordingly, the aim of the present invention is to overcome the above mentioned problem, by providing a novel method for controlling and putting down woodland fires, which allows to directly operate on the fire place, without necessarily using fire extinguishing water.

Within the scope of the above mentioned aim, a main object of the invention is to provide such a fire putting down method allowing to properly putting down and controlling fires in any phases thereof, without causing permanent damages to the encompassing environment.

Another object of the present invention is to provide such a fire putting down method which, owing to its specifically designed features is reliable and safe in operation.

According to one aspect of the present invention, the above mentioned aim and objects, as well as yet other objects, which will become more apparent hereinafter, are achieved by a method for controlling and putting down woodland fires, characterized in that said method comprises the steps of collecting earth from a region encompassing a fire region and projecting the collected earth on the combustion region and adjoining regions thereof.

### BRIEF DESCRIPTION OF THE DRAWINGS

Further characteristics and advantages of the present invention will become more apparent hereinafter from the following detailed disclosure of a preferred, though not exclusive, embodiment of a method for controlling and putting down woodland fires, which is illustrated, by way of an indicative, but not limitative, example in the accompanying drawings, where:

FIG. 1 is a schematic view showing an apparatus for taking and projecting earth, as seen in elevation;

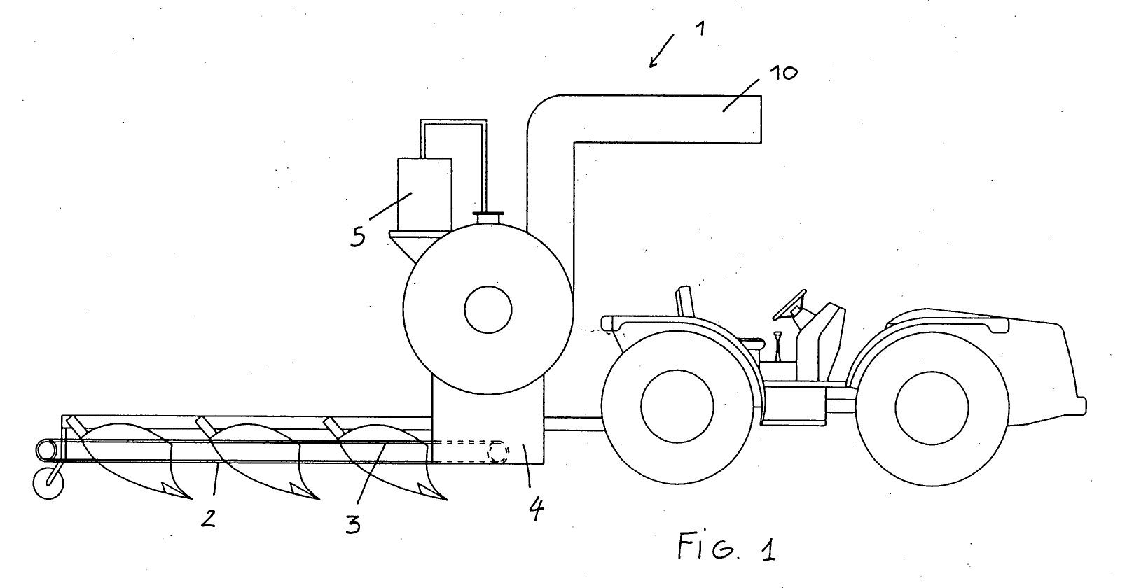

FIG. 2 is a top plan view of the inventive apparatus;

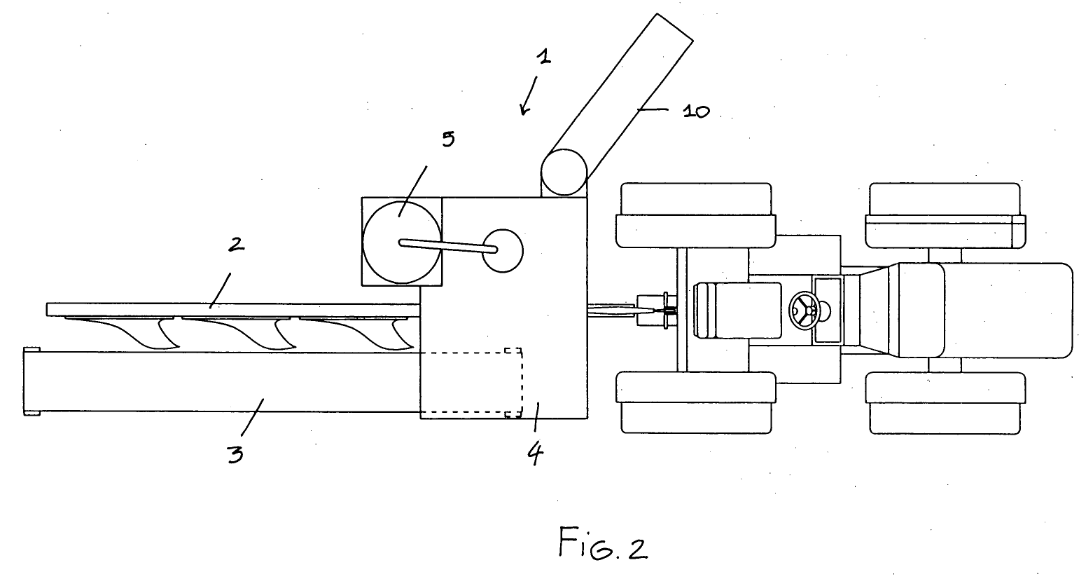

FIG. 3 is a further elevation view showing the subject apparatus during an operating step thereof for taking and projecting earth on a fire region; and

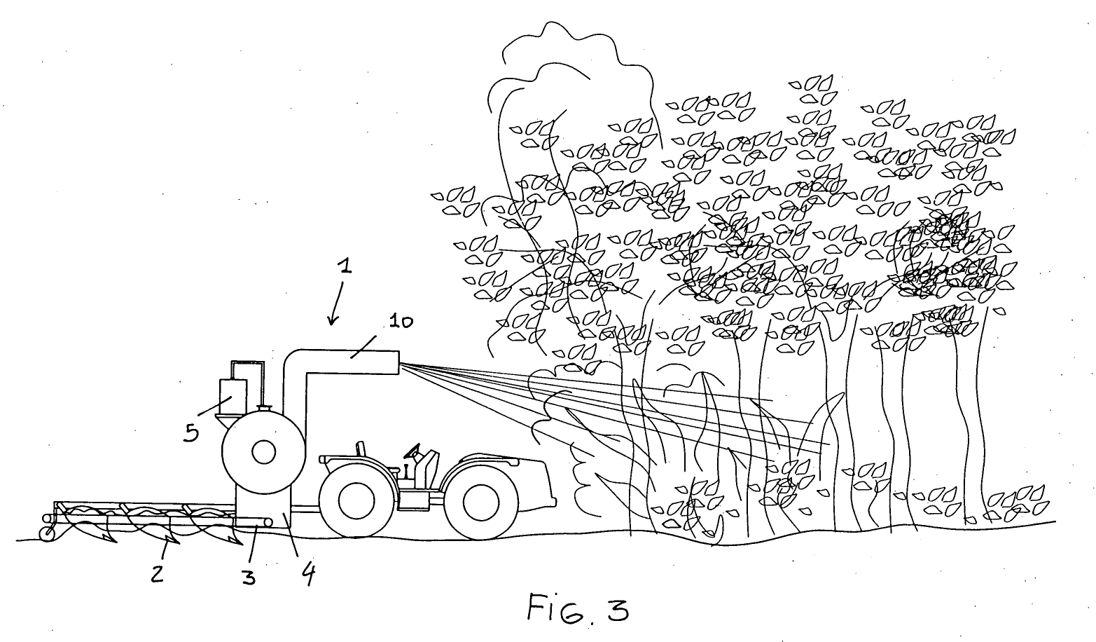

FIG. 4 is yet another top plan view showing a possible mode of use of the inventive apparatus.

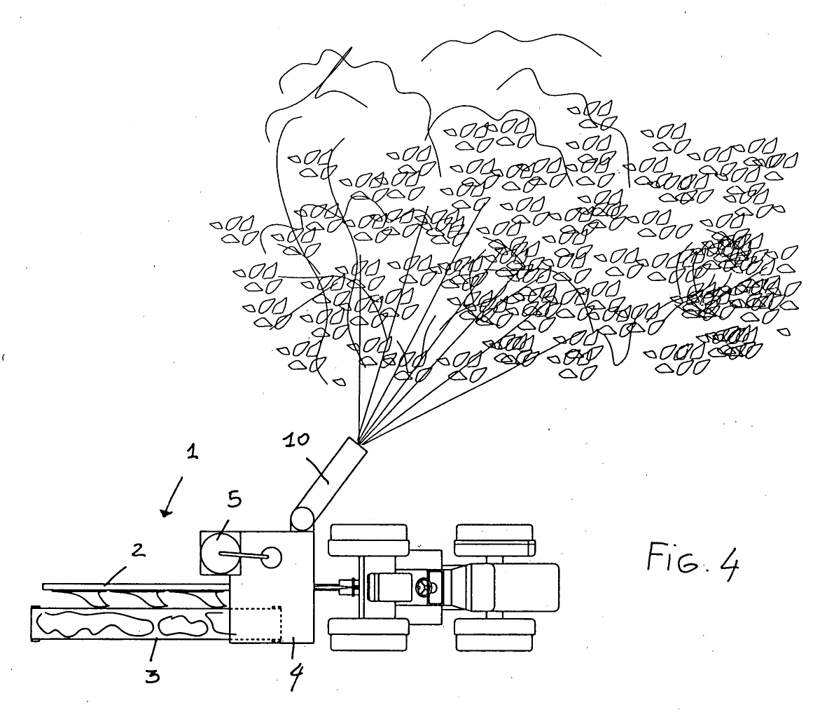

### DESCRIPTION OF THE PREFERRED EMBODIMENTS

With reference to the number references of the above mentioned figures, the method for controlling and putting down woodland fires and the like, according to the present invention, provides to take earth, which can be performed by any suitable earth taking means, in a region encompassing the fire region.

In this connection it should be apparent that with the term “earth” is herein intended any heterogeneous complex or mixture of materials having different mineralogical, chemical and biologic composition, depending on the rocks and organic components constituting it, and depending on novel chemical compounds which, because of different actions, would be formed therein, independently from its physical nature.

In particular, the taking operation can be performed either on the surface, or at a given depth of the ground, by any desired earth taking apparatus or method, and at any chemical or physical aggregating status and with any desired particle size and moisture contents.

According to a preferred, though not exclusive embodiment, the inventive method provides to use an earth taking apparatus, generally indicated by the reference number 1, including an earth taking assembly 2, designed for collecting earth from the ground and convey the collected earth, through a conveyor assembly 3, to an earth processing assembly 4, therein the collected earth will be processed according to any desired processing methods.

According to further preferred, though not exclusive, embodiments, at said earth processing assembly 4, it is provided to add to the collected earth chemical compounds, contained in a chemical compound tank 5, said chemical compounds having fire extinguishing characteristics, or consisting of any desired additive materials.

The thus processed earth is then fed to an earth projecting or ejecting assembly 10, designed for launching the collected and processed earth to the combustion region as well as adjoining regions thereof.

As it should be apparent, the mechanical ejecting of the collected earth, or a pressurized air ejecting therefor, will hinder, limit or prevent the combustion, that is the chemical reaction caused by a combination of a substance with oxygen, and frequently accompanied by a heat and like generation.

Thus, by the above disclosed apparatus, the collected and processed earth is launched or projected to the combustion regions as well as adjoining regions thereof, thereby absorbing oxygen and providing an additional non combustible material amount, such as the above mentioned taken and optionally processed earth, which would have been processed, for example, by grinding or fire extinguishing chemical product adding operations.

In this connection it should be further pointed out that the present invention, as above disclosed, specifically relates to an apparatus and method providing to use a mechanical injector assembly including entraining blades, adapted to drive free or precompressed earth masses, thereby to launch or project the latter to any desired direction.

The above mechanical ejector device, exploits the centrifugal force and is adapted to project or launch to target points of the ground the collected earth and, depending on requirements, precompressed earth masses, adapted to be launched thereby, or processed earth masses.

The earth masses, either in a free or in a compacted condition, will be mechanically driven and projected, by exploiting the centrifugal force and/or pulse type of mechanical principles.

From the above disclosure it should be apparent that the invention fully achieves the intended aim and objects.

In fact, the invention provides a method allowing to easily and quickly control and put-down or extinguish woodland fires, without causing permanent damages and without necessarily using water.

The invention, as disclosed, is susceptible to several modifications and variations, all of which will come within the scope of the invention.

Moreover, all the constructional and structural details can be replaced by other technically equivalent elements.

In practicing the invention, the used materials, provided that they are compatible to the intended use, as well as the contingent size and shapes, can be any, depending on requirements.

1. A method for controlling and putting down woodland fires, characterized in that said method comprises the steps of taking earth from a region encompassing the fire region and projecting the collected earth to the combustion regions and adjoining regions thereof.

2. A method, according to claim 1, characterized in that said method comprises the step of processing the taken earth by adding to said taken earth fire extinguishing chemical additives.

3. A method, according to claim 1, characterized in that said earth is processed by grinding said earth or by reducing said earth to a fragment size.

4. A method, according to claim 1, characterized in that said earth is projected by mechanical projecting means.

5. A method, according to claim 1, characterized in that said earth is projected by pressurized air jet means.

6. A method, according to claim 1, characterized in that to said taken earth is further added incombustible material for removing oxygen from the combustion region.

7. An apparatus for making a method according to claim 1, characterized in that said apparatus comprises an earth taking assembly, adapted to supply the taken earth to an earth processing assembly coupled to an earth projecting or launching assembly.

8. An apparatus, according to claim 7, characterized in that said apparatus comprises, at said earth processing assembly, a fire extinguishing additive holding tank.

9. An apparatus, according to claim 8, characterized in that said apparatus further comprises a mechanical ejecting device including a plurality of earth entraining blades designed for projecting masses of earth, either in a free or precompressed condition, to a desired direction.

10. An apparatus according to claim 8, characterized in that said apparatus comprises a mechanical ejector device which, by exploiting the centrifugal force, is adapted to project to desired regions the collected earth and, if required, precompressed earth masses, adapted to be launched thereby, or processed earth masses, said free or compacted earth masses being mechanically handled and ejected by exploiting a centrifugal force and a pulse type of mechanical principle.
